(19) United States
(12) Patent Application Publication
(10) Pub. No.: US 2025/0112984 A1
(43) Pub. Date: Apr. 3, 2025

(54) MOBILE ELECTRONIC DEVICE AND CALL VOLUME ADJUSTMENT METHOD THEREOF

(71) Applicant: ASUSTeK COMPUTER INC., Taipei City (TW)

(72) Inventors: Yi-Hsin Shang, Taipei City (TW); Jen-Pang Hsu, Taipei City (TW); Chao-Hsien Huang, Taipei City (TW)

(73) Assignee: ASUSTeK COMPUTER INC., Taipei City (TW)

(21) Appl. No.: 18/798,866

(22) Filed: Aug. 9, 2024

(30) Foreign Application Priority Data
Oct. 2, 2023 (TW) 112137661

(51) Int. Cl. H04M 1/60; H04M 1/72403; H04M 1/72454; H04M 3/22; H04M 3/42; H04M 19/04

(52) U.S. Cl. CPC H04M 1/6016; H04M 1/72403; H04M 1/72454; H04M 3/2218; H04M 3/42102; H04M 19/047

(57) ABSTRACT

A mobile electronic device and a call volume adjustment method thereof are provided. The call volume adjustment method is adapted to the mobile electronic device and includes the following steps. A callee of a call is identified. Whether a call record list includes the callee is judged. A call volume of the call is adjusted according to the callee based on record data in the call record list when the call record list includes the callee.

### CROSS-REFERENCE TO RELATED APPLICATION

This application claims the priority benefit of Taiwan application serial no. 112137661, filed on Oct. 2, 2023. The entirety of the above-mentioned patent application is hereby incorporated by reference herein and made a part of this specification.

### BACKGROUND

### Technical Field

The disclosure relates to a mobile electronic device and a call volume adjustment method thereof.

### Description of Related Art

With the continuous advancement of communication technology, more and more electronic equipment support voice call functions between equipment, which provides modern people with more communication options and convenience. Generally speaking, during a call, the surrounding call environment and the way the callee speaks may cause the user to feel that the call volume is too high or too low, so the user needs to adjust the call volume through the volume adjustment buttons. Although such manner of manually adjusting the call volume is simple, it has a certain impact on the call experience of the user. For example, such a manual adjustment process may introduce unnecessary interruptions in the call, sometimes even requiring the callee to repeat what they said to ensure that the message is received correctly. On the other hand, if the call volume is too loud at the beginning, the user may feel uncomfortable.

### SUMMARY

The disclosure provides a call volume adjustment method, which is adapted to a mobile electronic device. The call volume adjustment method includes the following steps. A callee of a call is identified. Whether a call record list includes the callee is judged. When the call record list includes the callee, a call volume of the call is adjusted according to the callee based on record data in the call record list.

The disclosure also provides a mobile electronic device, which includes a storage device and a processor. The storage device records multiple commands, and the processor is coupled to the storage device and executes the commands to execute the following steps. A callee of a call is identified. Whether a call record list includes the callee is judged. When the call record list includes the callee, a call volume of the call is adjusted according to the callee based on record data in the call record list.

Based on the above, in the disclosure, the mobile electronic device may automatically adjust the call volume to the preferred state of the user according to the callee. Therefore, in the embodiments of the disclosure, the call experience can be effectively improved, so that the call process becomes more convenient and satisfying.

### BRIEF DESCRIPTION OF THE DRAWINGS

FIG. 1 is a schematic diagram of a mobile electronic device according to an embodiment of the disclosure.

FIG. 2 is a flowchart of a call volume adjustment method according to an embodiment of the disclosure.

FIG. 3 is a flowchart of a call volume adjustment method according to an embodiment of the disclosure.

FIG. 4 is a flowchart of a call volume adjustment method according to an embodiment of the disclosure.

FIG. 5 is a flowchart of a call volume adjustment method according to an embodiment of the disclosure.

FIG. 6 is a flowchart of a call volume adjustment method according to an embodiment of the disclosure.

### DESCRIPTION OF THE EMBODIMENTS

Reference will now be made in detail to the exemplary embodiments of the disclosure, examples of which are illustrated in the drawings. Wherever possible, the same reference numerals are used in the drawings and the description to refer to the same or similar parts. The embodiments are only part of the disclosure and do not disclose all possible implementations of the disclosure. Rather, the embodiments are merely examples of devices and methods in the claims of the disclosure.

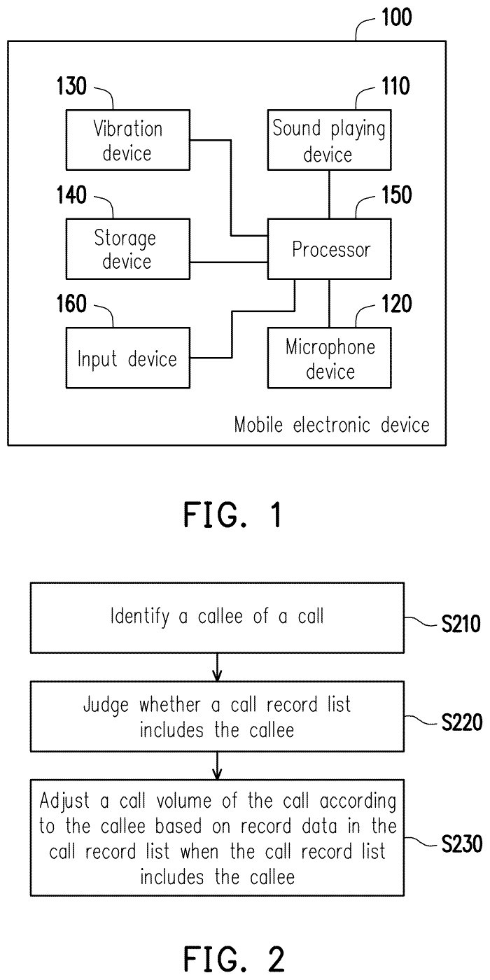

Please refer to FIG. 1. A mobile electronic device 100 is, for example, an electronic device with communication functions such as a smart phone and a tablet computer, and the disclosure is not limited thereto. The mobile electronic device 100 includes a sound playing device 110, a microphone device 120, a vibration device 130, a storage device 140, a processor 150, and an input device 160. The processor 150 is coupled to the sound playing device 110, the microphone device 120, the vibration device 130, and the storage device 140, and the functions thereof are described below.

The sound playing device 110 has an audio playing function and includes a speaker element for playing call audio, which may be, for example, an earpiece, a speaker, or an earphone, or the like. For example, when the mobile electronic device 100 operates in a handheld communication mode, the user may hear the call audio through an earpiece. When the mobile electronic device 100 operates in a loudspeaker mode, the user may hear the call audio through a speaker. When the mobile electronic device 100 operates in an earphone mode, the user may hear the call audio through an earphone.

The microphone device 120 is used to convert a sound wave into an electronic signal. In the disclosure, the microphone device 120 is used to receive ambient sound.

The vibration device 130 is used to provide vibration to remind the user and is, for example, a vibration motor, an electromagnetic vibrator, a piezoelectric vibrator, etc. The vibration time and the vibration intensity of the vibration device 130 are controllable.

The storage device 140 is used to store data such as files, commands, program codes, and software modules, and may be, for example, any type of fixed or removable random access memory (RAM), read-only memory (ROM), flash memory, and hard disk, other similar devices, an integrated circuit, or a combination thereof. In an embodiment of the disclosure, the storage device 140 may also be used to store a call record list.

The processor 150 is, for example, a central processing unit (CPU), an application processor (AP), other programmable general-purpose or specific-purpose microprocessors, digital signal processors (DSP), programmable controllers, application specific integrated circuits (ASIC), programmable logic devices (PLD), graphics processing units (GPU), other similar devices, or a combination of the devices. The processor 150 may execute the program codes, software modules, commands, etc. recorded in the storage device 140 to implement a call volume adjustment method according to an embodiment of the disclosure. The software modules may be broadly interpreted to mean commands, command sets, codes, program codes, programs, applications, software packages, threads, processes, functions, etc.

The input device 160 is used to receive a user operation and is, for example, a touch screen, physical buttons (for example, volume adjustment buttons), etc. The user may adjust a call volume through issuing the user operation to the input device 160.

Please refer to FIG. 1 and FIG. 2. The manner of the embodiment is adapted to the mobile electronic device 100 in the above embodiment. The detailed steps of the call volume adjustment method of the embodiment will be described below with reference to various elements in the mobile electronic device 100.

In Step S210, the processor 150 identifies a callee of a call. Specifically, when the mobile electronic device 100 receives a call, the processor 150 may identify the callee of the call. For example, the processor 150 may identify a phone number or a communication account of the callee. In addition, the call may be established based on various VOIP applications or other phone applications.

In Step S220, the processor 150 judges whether a call record list includes the callee. Specifically, the storage device 140 may record a call record list. Through querying the call record list according to the phone number or the communication account of the callee, the processor 150 may judge whether the call record list records the callee and corresponding call status information.

In Step S230, when the call record list includes the callee, the processor 150 adjusts the call volume of the call according to the callee based on record data in the call record list. On the other hand, when the call record list does not include the callee, the processor 150 records the callee and corresponding volume preference data in the call record list according to the user operation.

Specifically, when the user has made a call with a certain callee through the mobile electronic device 100, the processor 150 may obtain the preferred call volume of the user based on the user operation, and record the volume preference data generated based on the user operation in the call record list. In the call record list, each callee may be mapped to the corresponding volume preference data. It can be seen from this that when the user communicates with the callee again through the mobile electronic device 100, the processor 150 may obtain the volume preference data mapped to the callee from the call record list and automatically adjust the call volume accordingly. That is, the processor 150 may automatically adjust the call volume according to the callee, which can reduce the shortcomings caused by frequent manual adjustment of the call volume.

In some embodiments, processor 150 may set the call volume to one of multiple call volume levels. For example, the call volume levels include 5 levels, but not limited thereto. In some embodiments, taking the mobile electronic device 100 of the Android system as an example, the call volume of the call may be adjusted through AudioManager. AudioManager is used to provide an application programming interface (API) to control and access the audio stream, the volume, and the ringtone mode of an application.

It should be noted that in different embodiments, the volume preference data mapped to each callee in the call record list may include a preferred volume adjustment table or a preferred volume level, which will be respectively explained with the following embodiments.

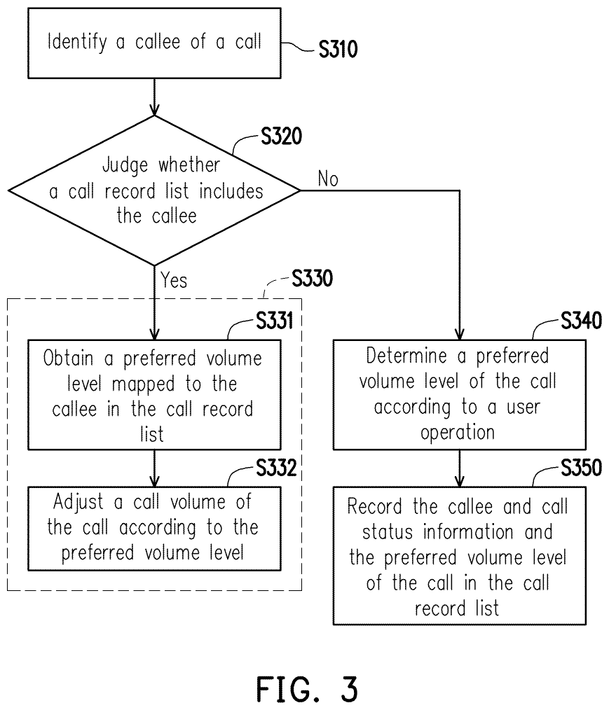

Please refer to FIG. 1 and FIG. 3. The manner of the embodiment is adapted to the mobile electronic device 100 in the above embodiment. The detailed steps of the call volume adjustment method of the embodiment are described below with reference to various elements in the mobile electronic device 100.

In Step S310, the processor 150 identifies a callee of a call. In Step S320, the processor 150 judges whether the call record list includes the callee. For the above steps, reference may be made to the description of the above embodiment and will not be described again here.

If the judgement of Step S320 is no, in Step S340, when the call record list does not include the callee, the processor 150 determines a preferred volume level of the call according to the user operation. In Step S350, the processor 150 records the callee and the call status information and the preferred volume level of the call in the call record list.

Specifically, if the callee is not recorded in the call record list (for example, the user has not made a call with the callee via the mobile electronic device 100), the processor 150 cannot obtain the preferred volume level mapped to the callee from the call record list. Therefore, in some cases, the user may adjust the call volume of the call to the preferred volume level via the input device 160, and the processor 150 may record the preferred volume level corresponding to the callee into the call record list.

In some embodiments, if the user does not issue any user operation to adjust the volume during the call, the preferred volume level is an initial volume level set by the processor 150 at the beginning of the call. In addition, if the user issues the user operation to adjust the volume during the call, the preferred volume level is a call volume level set by the user operation. For example, during the call, the processor 150 receives the user operation to adjust the call volume to one of multiple call volume levels, and records the one of the call volume levels as the preferred volume level.

More specifically, the call record list may record the preferred volume level mapped to each callee, and the preferred volume level mapped to each callee is one of the call volume levels. In addition, in some embodiments, in addition to the preferred volume level mapped to each callee, the call record list may record the call status information. The call status information may include the call application and the type of the sound playing device 110. For example, Table 1 is an example of the call record list.

TABLE 1

| Phone number or | Preferred | | |
|---|---|---|---|
| communication | volume | | Type of sound |
| account of callee | level | Call application | playing device |
| 091x-xoxoxo | 3 | Call application A | Earpiece |
| Phoebe | 1 | Call application B | Bluetooth |
| | | | earphone |
| Phoebe | 2 | Call application C | Earpiece |

On the other hand, if the judgement of Step S320 is yes, in Step S330, when the call record list includes the callee, the processor 150 adjusts the call volume of the call according to the callee based on the record data in the call record list. In the embodiment shown in FIG. 3, Step S330 may be implemented as Step S331 and Step S332.

In Step S331, the processor 150 obtains the preferred volume level mapped to the callee in the call record list. In Step S332, the processor 150 adjusts the call volume of the call according to the preferred volume level. Taking Table 1 as an example, when the processor 150 identifies the phone number of the callee as “091x-xoxoxo”, the processor 150 may obtain the preferred volume level mapped to the callee from the call record list as “level 3”. Therefore, the processor 150 may adjust the call volume of the call to “level 3”.

In some embodiments, the processor 150 may determine the preferred volume level from the call record list according to the callee and the call status information of the call. The call status information may include the call application and the type of the sound playing device 110. Taking Table 1 as an example, when the processor 150 identifies that the communication account of the callee is “Phoebe” and the call application of the call is “Call application C”, the processor 150 may obtain the preferred volume level mapped to the callee from the call record list as “level 2”. Therefore, the processor 150 may adjust the call volume of the call to “level 2”. When the processor 150 identifies that the communication account of the callee is “Phoebe” and the call application of the call is “Call application B”, the processor 150 may obtain the preferred volume level mapped to the callee from the call record list as “level 1”. As a result, the processor 150 may adjust the call volume of the call to “level 1”. It may be seen that the mobile electronic device 100 may also automatically adjust the call volume according to the callee and the type of the call application.

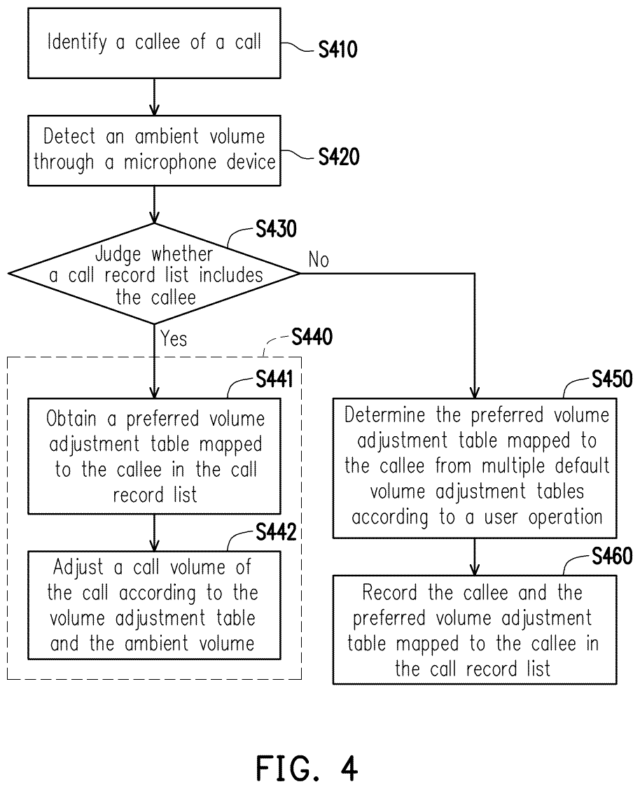

Please refer to FIG. 1 and FIG. 4. The manner of the embodiment is adapted to the mobile electronic device 100 in the above embodiment. The detailed steps of the call volume adjustment method of the embodiment will be described below with reference to various elements in the mobile electronic device 100.

In Step S410, the processor 150 identifies a callee of a call. In Step S420, the processor 150 detects an ambient volume through the microphone device 120. Specifically, when the mobile electronic device 100 adjusts the call volume according to the ambient volume, the microphone device 120 may detect the ambient volume (unit: decibel).

In Step S430, the processor 150 judges whether the call record list includes the callee. If the judgement of Step S430 is no, in Step S450, when the record list does not include the callee, the processor 150 determines the preferred volume adjustment table mapped to the callee from multiple default volume adjustment tables according to the user operation. In Step S460, the processor 150 records the callee and the preferred volume adjustment table mapped to the callee in the call record list.

In the embodiment, the processor 150 searches a volume adjustment table according to the ambient volume to obtain a corresponding target call volume level. Specifically, if the callee is not recorded in the call record list (for example, the user has not made a call with the callee via the mobile electronic device 100), the processor 150 cannot obtain the preferred volume adjustment table mapped to the callee from the call record list. Therefore, in the case where a default first default volume adjustment table is used for volume adjustment, the user may issue the user operation via the input device 160 to increase or decrease the call volume of the call. The first default volume adjustment table is one of multiple default volume adjustment tables stored in the storage device 140. Correspondingly, the processor 150 may determine the preferred volume adjustment table of the callee according to whether the user operation is a volume increase command or a volume decrease command and the first default volume adjustment table. Therefore, the processor 150 may record the preferred volume adjustment table corresponding to the callee into the call record list.

For example, Table 2 is an example of the call record list.

TABLE 2

| Phone number or communication | Preferred volume |
|---|---|
| account of callee | adjustment table |
| 091x-xoxoxo | First default volume |
| | adjustment table |
| Phoebe | Second default volume |
| | adjustment table |

In some embodiments, if the user does not issue any user operation to adjust the volume during the call, the preferred volume adjustment table is the first default volume adjustment table set by the processor 150 at the beginning of the call. In addition, if the user issues the user operation to adjust the volume during the call, the preferred volume adjustment table corresponding to the callee is decided to be a second default volume adjustment table different from the first default volume adjustment table. The second default volume adjustment table is one of the default volume adjustment tables stored in the storage device 140.

For example, Table 3 is an example of the default volume adjustment tables. However, the number and the values of the default volume adjustment tables are only exemplary and are not limited by the disclosure.

TABLE 3

| | Third | Second | First default | Fourth | Fifth |
|---|---|---|---|---|---|
| | default | default | volume | default | default |
| Call | volume | volume | adjustment | volume | volume |
| volume | adjustment | adjustment | table | adjustment | adjustment |
| level | table | table | (standard) | table | table |
| 1 | Ns <= 47 | Ns <= 44 | Ns <= 42 | Ns <= 39 | Ns <= 36 |
| 2 | 47 < Ns <= 65 | 44 < Ns <= 52 | 42 < Ns <= 50 | 39 < Ns <= 47 | 36 < Ns <= 40 |
| 3 | 65 < Ns <= 70 | 52 < Ns <= 57 | 50 < Ns <= 55 | 47 < Ns <= 52 | 40 < Ns <= 45 |
| 4 | 70 < Ns <= 80 | 57 < Ns <= 67 | 55 < Ns <= 62 | 52 < Ns <= 57 | 45 < Ns <= 50 |
| 5 | Ns > 80 | Ns > 67 | Ns > 62 | Ns > 57 | Ns > 50 |

Wherein Ns represents the ambient volume. In the example of Table 3, the first default volume adjustment table is a standard default volume adjustment table. In the case where the processor 150 cannot obtain the preferred volume adjustment table of the callee from the call record list, the processor 150 may choose to use the first default volume adjustment table to adjust the call volume. For example, in the case where the processor 150 adjusts the call volume using the first default volume adjustment table, if the ambient volume is between 42 dB and 50 dB, the processor 150 adjusts the call volume to “level 2”.

Based on the above, when the processor 150 uses the default first default volume adjustment table, the user may be dissatisfied with the call volume and issue the user operation to adjust the volume. Based on the example of Table 3, if the user is dissatisfied with the call volume set based on the first default volume adjustment table and the user operation is the volume decrease command, the processor 150 may determine that the preferred volume adjustment table of the callee is the second default volume adjustment table. If the user is dissatisfied with the call volume set based on the first default volume adjustment table and the user operation is the volume increase command, the processor 150 may determine that the preferred volume adjustment table of the callee is a third default volume adjustment table. If the user is satisfied with the call volume set based on the first default volume adjustment table and does not issue the user operation to adjust the volume, the processor 150 may determine that the preferred volume adjustment table of the callee is the first default volume adjustment table. Based on this, the processor 150 may record the preferred volume adjustment table of the callee to the call record list according to the user operation.

On the other hand, if the judgement of Step S430 is yes, in Step S440, when the call record list includes the callee, the processor 150 adjusts the call volume of the call according to the callee based on the record data in the call record list. In the embodiment shown in FIG. 4, Step S440 may be implemented as Step S441 and Step S442.

In Step S441, the processor 150 obtains the preferred volume adjustment table mapped to the callee in the call record list. In Step S442, the processor 150 adjusts the call volume of the call according to the volume adjustment table and the ambient volume. Taking Table 2 and Table 3 as an example, when the processor 150 identifies the phone number of the callee as “091x-xoxoxo”, the processor 150 may obtain the preferred volume adjustment table mapped to the callee from the call record list as the first default volume adjustment table. Therefore, the processor 150 may adjust the call volume according to the first default volume adjustment table.

In some embodiments, the processor 150 judges that the ambient volume falls within one of multiple volume ranges of the preferred volume adjustment table. The processor 150 adjusts the call volume of the call according to the call volume level corresponding to the one of the volume ranges. Taking Table 2 and Table 3 as an example, when the processor 150 identifies the communication account of the callee as “Phoebe”, the processor 150 may obtain the preferred volume adjustment table mapped to the callee from the call record list as the second default volume adjustment table. Next, the processor 150 judges that the ambient volume falls within one of the volume ranges of the preferred volume adjustment table (that is, the second default volume adjustment table). The volume ranges are respectively “less than or equal to 44 decibels”, “greater than 44 decibels and less than or equal to 52 decibels”, “greater than 52 decibels and less than or equal to 57 decibels”, “greater than 57 decibels and less than or equal to 67 decibels”, and “greater than 67 decibels”. Assuming that the processor 150 judges that the ambient volume falls within the volume range of “less than or equal to 44 decibels” in the preferred volume adjustment table, the processor 150 adjusts the call volume to “level 1”.

It should be noted that in some embodiments, the storage device 140 may simultaneously store the call record list of the embodiment of FIG. 3 (hereinafter referred to as a first call record list) and the call record list of the embodiment of FIG. 4 (hereinafter referred to as a second call record list). The processor 150 may determine whether to use the first call record list or the second call record list to adjust the call volume according to an automatic volume adjustment mode set by the user.

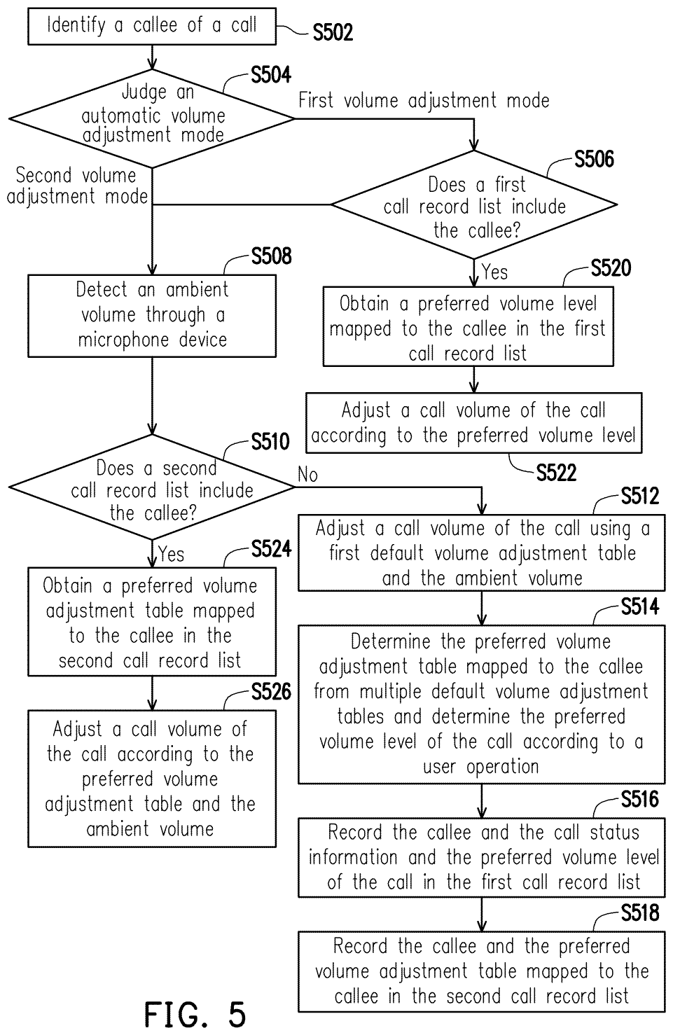

Please refer to FIG. 1 and FIG. 5. The manner of the embodiment is adapted to the mobile electronic device 100 in the above embodiment. The detailed steps of the call volume adjustment method of the embodiment are described below with reference to various elements in the mobile electronic device 100.

In Step S502, the processor 150 identifies the callee of the call. In Step S504, the processor 150 judges whether the automatic volume adjustment mode selected by the user is a first volume adjustment mode or a second volume adjustment mode. If the automatic volume adjustment mode is the first volume adjustment mode, in Step S506, the processor 150 judges whether the first call record list includes the callee. If the first call record list does not include the callee (the judgement of Step S506 is no), the processor 150 may determine to switch to the second volume adjustment mode and enter Step S508.

If the automatic volume adjustment mode is the second volume adjustment mode, in Step S508, the processor 150 detects the ambient volume through the microphone device 120. Then, in Step S510, the processor 150 judges whether the second call record list includes the callee.

If the second call record list does not include the callee (the judgement of Step S510 is no), in Step S512, the processor 150 adjusts the call volume of the call using the first default volume adjustment table and the ambient volume. In Step S514, according to the user operation, the processor 150 determines the preferred volume adjustment table mapped to the callee from the default volume adjustment tables and determines the preferred volume level of the call. In Step S516, the processor 150 records the callee and the call status information and the preferred volume level of the call in the first call record list. In Step S518, the processor 150 records the callee and the preferred volume adjustment table mapped to the callee in the second call record list.

If the second call record list includes the callee (the judgement of Step S510 is yes), in Step S524, the processor 150 obtains the preferred volume adjustment table mapped to the callee in the second call record list. In Step S526, the processor 150 adjusts the call volume of the call according to the preferred volume adjustment table and the ambient volume.

If the first call record list includes the callee (the judgement of Step S506 is no), in Step S520, the processor 150 obtains the preferred volume level mapped to the callee in the first call record list. In Step S522, the processor 150 adjusts the call volume of the call according to the preferred volume level. For detailed implementation details of each step shown in FIG. 5, reference may be made to the description of the above embodiment and will not be described again here.

It is worth noting that in some embodiments, when the user issues the user operation to adjust the volume through the input device 160 during the call, the processor 150 may provide a corresponding feedback prompt to the user through controlling the vibration intensity and the vibration time of the vibration device 130.

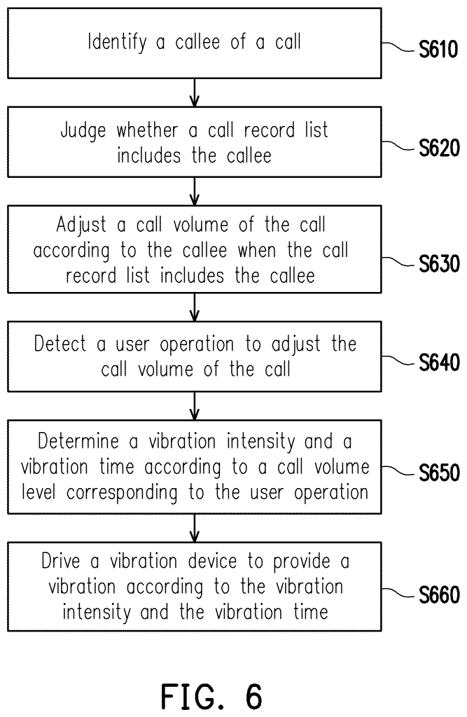

Please refer to FIG. 1 and FIG. 6. The manner of the embodiment is adapted to the mobile electronic device 100 in the above embodiment. The detailed steps of the call volume adjustment method of the embodiment are described below with reference to various elements in the mobile electronic device 100.

In Step S610, the processor 150 identifies a callee of a call. In Step S620, the processor 150 judges whether the call record list includes the callee. In Step S630, when the call record list includes the callee, the processor 150 adjusts the call volume of the call according to the callee based on the record data in the call record list.

It should be noted that in Step S640, the processor 150 detects the user operation to adjust the call volume of the call. When the user issues the volume increase command or the volume decrease command through the input device 160 during the call, the processor 150 may detect the user operation to adjust the call volume.

In Step S650, the processor 150 determines the vibration intensity and the vibration time according to the call volume level corresponding to the user operation. In response to receiving the user operation, the processor 150 may adjust the call volume from an initial call volume level to the call volume level corresponding to the user operation. In some embodiments, the processor 150 may determine the vibration intensity and the vibration time according to a comparison result between the initial call volume level and the call volume level corresponding to the user operation. For example, the processor 150 may determine the vibration time according to a level difference between the initial call volume level and the call volume level corresponding to the user operation. The vibration time may be positively correlated with the level difference. The processor 150 may determine the vibration intensity and the vibration time through a lookup table or a default function. Alternatively, when the initial call volume level is higher than the call volume level corresponding to the user operation, the processor 150 may set the vibration intensity to weak intensity. When the initial call volume level is lower than the call volume level corresponding to the user operation, the processor 150 may set the vibration intensity to high intensity.

In Step S660, the processor 150 drives the vibration device 130 to provide a vibration according to the vibration intensity and the vibration time. In this way, the user may know whether the call volume is changing in an expected manner according to the vibration.

In summary, in the embodiments of the disclosure, the call volume may be automatically adjusted according to the user preference and the callee, which helps to ensure that the call can proceed smoothly without having to worry about adjusting the volume, thereby improving communication quality. In addition, in the embodiments of the disclosure, when the user adjusts the call volume, the corresponding vibration prompt may be obtained, thereby preventing the occurrence of incorrect volume adjustment and improving the smoothness of the call.

Finally, it should be noted that the above embodiments are only used to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

What is claimed is:

1. A call volume adjustment method, adapted to a mobile electronic device, the call volume adjustment method comprising:
identifying a callee of a call;
judging whether a call record list comprises the callee; and
adjusting a call volume of the call according to the callee based on record data in the call record list when the call record list comprises the callee.

2. The call volume adjustment method according to claim 1, wherein the step of adjusting the call volume of the call according to the callee when the call record list comprises the callee comprises:
obtaining a preferred volume level mapped to the callee in the call record list; and
adjusting the call volume of the call according to the preferred volume level.

3. The call volume adjustment method according to claim 2, wherein the step of obtaining the preferred volume level mapped to the callee in the call record list comprises:
determining the preferred volume level from the call record list according to the callee and call status information of the call.

4. The call volume adjustment method according to claim 3, wherein the call status information of the call comprises a call application and a type of a sound playing device.

5. The call volume adjustment method according to claim 2, further comprising:
determining a preferred volume level of the call according to a user operation when the call record list does not comprise the callee; and
recording the callee and call status information and the preferred volume level of the call in the call record list.

6. The call volume adjustment method according to claim 1, further comprising:
detecting an ambient volume through a microphone device,
wherein the step of adjusting the call volume of the call according to the callee when the call record list comprises the callee comprises:
obtaining a preferred volume adjustment table mapped to the callee in the call record list; and
adjusting the call volume of the call according to the preferred volume adjustment table and the ambient volume.

7. The call volume adjustment method according to claim 6, wherein the step of adjusting the call volume of the call according to the preferred volume adjustment table and the ambient volume comprises:
judging that the ambient volume falls within one of a plurality of volume ranges of the preferred volume adjustment table; and
adjusting the call volume of the call according to a call volume level corresponding to the one of the volume ranges.

8. The call volume adjustment method according to claim 6, further comprising:
determining the preferred volume adjustment table mapped to the callee from a plurality of default volume adjustment tables according to a user operation when the call record list does not comprise the callee; and
recording the callee and the preferred volume adjustment table mapped to the callee in the call record list.

9. The call volume adjustment method according to claim 1, wherein the mobile device comprises a vibration device, the call volume adjustment method further comprising:
detecting a user operation to adjust the call volume of the call;
determining a vibration intensity and a vibration time according to a call volume level corresponding to the user operation; and
driving the vibration device to provide a vibration according to the vibration intensity and the vibration time.

10. A mobile electronic device, comprising:
a storage device, recording a plurality of commands;
a processor, coupled to the storage device, executing the commands, and configured to:
identify a callee when a call is made via the mobile electronic device;
judge whether a call record list comprises the callee; and
adjust a call volume of the call according to the callee based on record data in the call record list when the call record list comprises the callee.
